(19) United States
(12) Patent Application Publication
(10) Pub. No.: US 2018/0336232 A1
(43) Pub. Date: Nov. 22, 2018

(54) ANALYSIS SYSTEM, ANALYSIS METHOD, AND COMPUTER-READABLE RECORDING MEDIUM

(71) Applicant: FUJITSU LIMITED, Kawasaki-shi (JP)

(72) Inventors: Takahiro OKUBO, Yokohama (JP); Masahiro KATAOKA, Kamakura (JP); Yasuhiro TSUYUKI, Numazu (JP)

(73) Assignee: FUJITSU LIMITED, Kawasaki-shi (JP)

(21) Appl. No.: 15/980,205

(22) Filed: May 15, 2018

(30) Foreign Application Priority Data
May 16, 2017 (JP) 2017-097666

(51) Int. Cl. G06F 17/30

(52) U.S. Cl. CPC G06F 17/30321

(57) ABSTRACT

An analysis system of an embodiment includes a terminal and a server. The terminal includes a first processor configured to collect a log of an operation of the terminal, or a log of sensing information that is acquirable in the terminal and create coded information obtained by encoding the log, or an inverted index indicating an appearance position in the log of a word included in the log that uses the coded information. The server includes a second processor configured to acquire the coded information or the inverted index from the terminal, and when the coded information is acquired, create the inverted index, and analyze information related to the terminal, using the inverted index.

### CROSS-REFERENCE TO RELATED APPLICATION

This application is based upon and claims the benefit of priority of the prior Japanese Patent Application No. 2017-097666, filed on May 16, 2017, the entire contents of which are incorporated herein by reference.

### FIELD

The embodiments discussed herein are related to an analysis system, an analysis method, and a computer-readable recording medium.

### BACKGROUND

There has been conventionally known a system that identifies interests and tastes of a user who uses a mobile terminal, by collecting and analyzing logs of application operations and the like in the mobile terminal, in a server, and creates and delivers recommendation information specialized for the user. Such recommendation information is frequently updated.

For example, when a user refers to various products in an web shopping service on a personal computer, recommendation information including related software, peripheral devices, and the like is displayed based on a selection result of a main body of a desktop or laptop personal computer, or the like.

In recent years, a technology in which a mobile terminal transmits a compressed log to a server for reducing transfer load, and the server performs analysis based on the compressed log is expected. For example, a technology of partially decompressing compressed files, and a technology of efficiently searching a log are disclosed.

In addition, for searching a log when analyzing the log, the server creates an inverted index indicating a word included in the log, a document ID including each word, and a position of the word, using a programming model such as MapReduce. Specifically, creation of an inverted index using the MapReduce will be described with reference to FIG. 13. FIG. 13 is an explanatory diagram for describing creation of a conventional inverted index. As exemplified in FIG. 13, a server lists words included in a document separated into words, and associates a document ID of a document that is included for each word, and a position in the document, thereby creating an inverted index. At this time, as exemplified in FIG. 13, the inverted index is created through three-path processing including separating a document into words (path 1), creating a word list (path 2), and integrating duplications (path 3). In the example illustrated in FIG. 13, for example, it is illustrated that a word “This” appears at two locations of the 0th place of a document A and the 0th place of a document B.

Patent Literature 1: Japanese Laid-open Patent Publication No. 2012-141830

Patent Literature 2: International Publication Pamphlet No. WO 2013/136418

### SUMMARY

According to an aspect of an embodiment, an analysis system includes a terminal and a server, wherein the terminal includes a first processor configured to: collect a log of an operation of the terminal or a log of sensing information that is acquirable in the terminal; and create coded information obtained by encoding the log, or index information indicating an appearance position in the log of a word included in the log that uses the coded information, and wherein the server includes a second processor configured to: acquire the coded information or the index information from the terminal, and when the coded information is acquired, create the index information; and analyze information related to the terminal, using the index information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram for describing analysis processing of a first embodiment;

FIG. 2 is a functional block diagram illustrating a configuration of an analysis system according to the first embodiment;

FIG. 3 is a diagram exemplifying logs;

FIG. 4 is an explanatory diagram for describing processing of an encoding unit according to the first embodiment;

FIG. 5 is an explanatory diagram for describing processing of the encoding unit according to the first embodiment;

FIG. 6 is an explanatory diagram for describing processing of an analysis unit;

FIG. 7 is a diagram illustrating a flow of analysis processing according to the first embodiment;

FIG. 8 is a diagram illustrating a flow of conventional analysis processing;

FIG. 9 is a diagram illustrating a flow of analysis processing according to a second embodiment;

FIG. 10 is a diagram illustrating a flow of analysis processing according to a third embodiment;

FIG. 11 is an explanatory diagram for describing an inverted index according to an application example;

FIG. 12 is a diagram illustrating a hardware configuration example of a computer that executes an analysis program; and

FIG. 13 is an explanatory diagram for describing creation of a conventional inverted index.

### DESCRIPTION OF EMBODIMENTS

Nevertheless, in the case of compressing collected logs in a mobile terminal, in a conventional compression format such as ZIP, it is impossible to stably increase a compression rate unless a large amount of logs are compressed at a time. In addition, if a large amount of compression target logs are compressed at a time in a mobile terminal, a memory and a storage resource of the mobile terminal become scarce. In addition, for creating an inverted index needed for search and analysis of logs received by the server, logs compressed in a conventional format need to be expanded, and processing cost increases.

Preferred embodiments will be explained with reference to accompanying drawings. In addition, the embodiments are not intended to limit the disclosed technology. In addition, the embodiments can be appropriately combined without causing contradiction in processing content.

### [a] First Embodiment

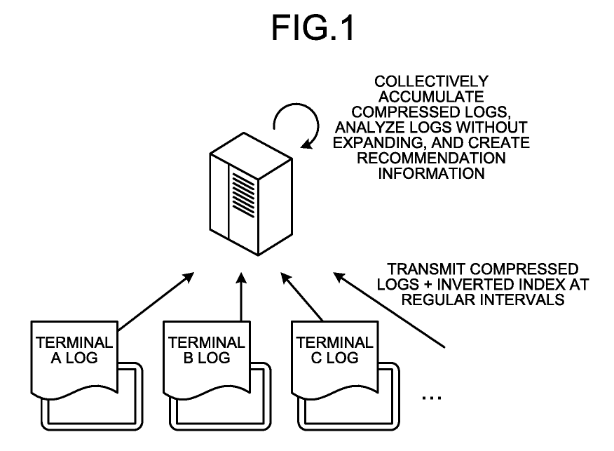

Description of Analysis Processing FIG. 1 is an explanatory diagram for describing analysis processing of a first embodiment. As illustrated in FIG. 1, in the present embodiment, a terminal collects and accumulates logs of operations performed by users, sensing information that is acquirable in the terminal, or the like, compresses the accumulated logs at a regular interval, and transmits the compressed logs to a server. In addition, when compressing logs, the terminal together creates an inverted index serving as an example of index information, through one-path processing, and transmits the created inverted index to the server. The server accumulates received compressed logs, and searches and analyzes the accumulated compressed logs without expanding, using the received inverted index, thereby creating recommendation information for a user with suppressed load.

System Configuration

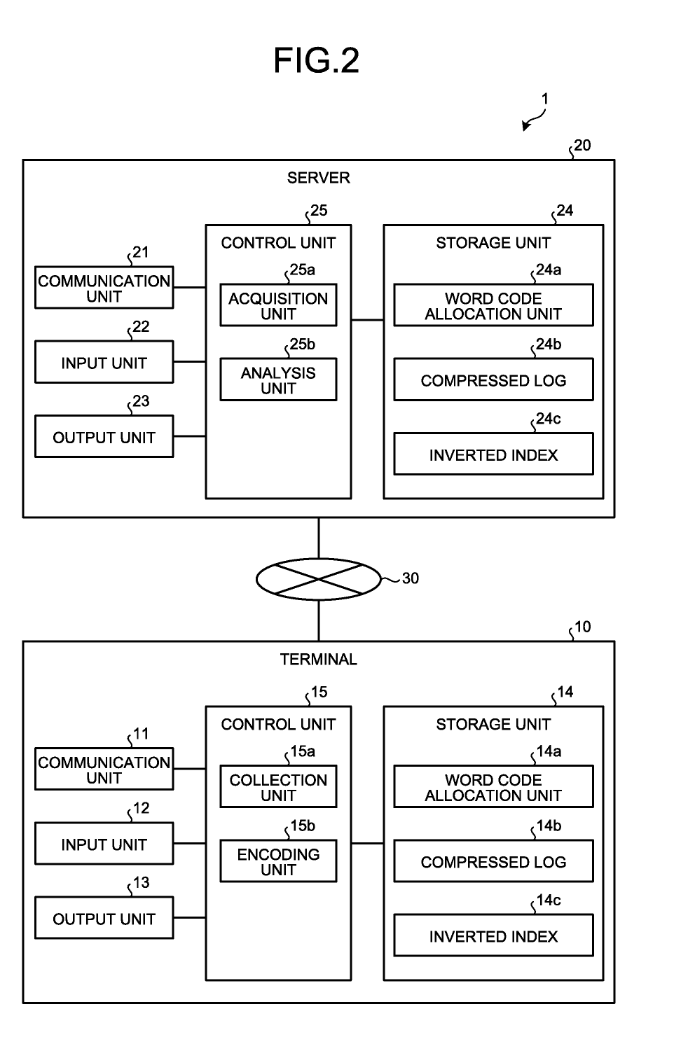

FIG. 2 is a functional block diagram illustrating a configuration of an analysis system 1 according to the first embodiment. As illustrated in FIG. 2, the analysis system 1 includes a terminal 10 and a server 20, which are connected to each other via a network 30 such as a local area network (LAN) and the internet, so as to be able to perform communication.

The terminal 10 is implemented by a mobile terminal wirelessly connected to the network 30, for example. A plurality of terminals 10, which are not illustrated in the drawing, exists, and the terminals 10 are used by respective different users. Through analysis processing to be described later, the terminal 10 receives operation input of an application or the like that is performed by the user, collects and accumulates logs of operations, compresses accumulated logs, and transmits the compressed logs to the server 20. In addition, the terminal 10 presents recommendation information created by the server 20, to the user. In addition, the terminal 10 may directly perform communication with the server 20 not via the network 30, by wireless communication such as Bluetooth (registered trademark). In addition, the terminal 10 is not limited to a mobile terminal, and may be connected to the network 30 in a wired manner.

The server 20 is a server device that acquires logs of operations or the like of the terminal 10 that are performed by the user, analyzes the logs, creates recommendation information for the user of the logs, and delivers the recommendation information to the corresponding terminal 10. Through the analysis processing to be described later, the server 20 of the present embodiment acquires compressed logs from the terminal 10, and creates an inverted index used for search in analyzing logs.

Configuration of Terminal

As an embodiment, the terminal 10 can be implemented by the above-described analysis processing installing, onto a desired computer, an analysis program provided as packaged software or online software. For example, the terminal 10 can be implemented by installing the above-described analysis program onto an information processing apparatus used by the user. In addition to this, the terminal 10 can be implemented by installing the above-described analysis program onto a server device that accommodates an information processing apparatus used by the above-described user, or the like, as a client terminal. In this case, the terminal 10 may be implemented as part of a business system such as sales amount management, or may be implemented as a cloud that provides a service realized by the above-described analysis processing, by outsourcing.

Functional units corresponding to signs 11 to 15 are illustrated in FIG. 2, but these functional units merely serve as an example, and do not prevent part of functional units illustrated in the drawing, from being omitted, or a functional unit other than those illustrated in the drawing, from being included in the terminal 10. For example, when an information processing apparatus used by the user is implemented as the terminal 10, in addition to functional units included in a personal computer, a portable terminal device, or the like, as a standard, such as an input device, an output device of an image or sound, and a communication interface, for example, a functional unit such as a reading unit such as a scanner may be included. In addition, when the terminal 10 is implemented as part of the above-described business system, a database that manages data that is other than a word code allocation unit 14a, a compressed log 14b, and an inverted index 14c, which will be described later, may be stored in a storage unit 14 of the terminal 10, such as a mains storage device and an auxiliary storage device, for example.

As illustrated in FIG. 2, as a mere example, the terminal 10 includes a communication unit 11, an input unit 12, an output unit 13, the storage unit 14, and a control unit 15. In addition, in FIG. 2, solid lines representing relationship of input and output of data are illustrated. Nevertheless, for the sake of convenience of description, only minimum parts are illustrated. In other words, input and output of data that are related to each processing unit are not limited to the example illustrated in the drawing, and input and output of data that are other than those illustrated in the drawing may be performed. For example, input and output of data between a processing unit and a processing unit, between a processing unit and data, or between a processing unit and an external device may be performed.

The communication unit 11 is a processing unit that controls, via the network 30, data communication between an external device such as the server 20, and the control unit 15. The communication unit 11 corresponds to a communication device such as a network interface card (NIC), for example.

The input unit 12 is an input device for inputting various types of information to the terminal 10. For example, the input unit 12 corresponds to a mouse, a keyboard, a touch panel, an input button, or the like.

The output unit 13 is a display device that displays various types of information. For example, the output unit 13 corresponds to a display device such as a liquid crystal display (LCD) and a cathode ray tube (CRT).

The storage unit 14 is a device that stores data used in an operating system (OS) executed by the control unit 15, or various programs such as an application program. For example, the storage unit 14 is implemented as a main storage device in the terminal 10. For example, as the storage unit 14, various semiconductor memory elements such as, for example, a random access memory (RAM) and a flash memory can be employed. In addition, the storage unit 14 can also be implemented as an auxiliary storage device. In this case, a hard disk drive (HDD), an optical disk, a solid state drive (SSD), or the like can be employed.

As an example of data used in programs executed by the control unit 15, the storage unit 14 stores the word code allocation unit 14a, the compressed log 14b, and the inverted index 14c, which will be described later. In addition to the data, other types of electrical data can also be stored together in the storage unit 14.

The control unit 15 includes an internal memory that stores various programs and control data, and executes various types of processing using these.

For example, the control unit 15 is implemented as a central processor, that is to say, a so-called central processing unit (CPU). The control unit 15 needs not be always implemented as a central processor, and may be implemented as a micro processing unit (MPU) or a digital signal processor (DSP). In this manner, the control unit 15 is implemented as a processor, and a type thereof is not especially limited to a general-purpose type or a specialized type. In addition, the control unit 15 can also be realized by a hard-wired logic such as an application specific integrated circuit (ASIC) and a field programmable gate array (FPGA).

By executing various programs, the control unit 15 virtually realizes the following processing units. For example, the control unit 15 includes a collection unit 15a and an encoding unit 15b as illustrated in FIG. 2.

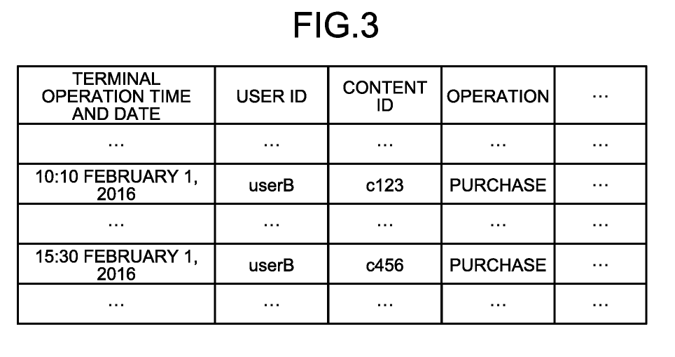

The collection unit 15a is a processing unit that collects logs of operations of the terminal 10, or logs of sensing information that is acquirable in the terminal 10. For example, the collection unit 15a collects, for each user, logs of product purchase, site browse, and the like. FIG. 3 is a diagram exemplifying logs collected by the collection unit 15a. For example, FIG. 3 exemplifies a log indicating that a user whose user ID for identifying the user is “userB” has performed an operation of “purchasing” a product having content ID “c123” for identifying the product, at 10:10, Feb. 1, 2016. In this manner, a log collected in the present embodiment is separated into items such as terminal operation time and date, a user ID, a content ID, and an operation, and a word representing content corresponding each item is described.

The encoding unit 15b is a processing unit that creates coded information obtained by encoding logs collected by the collection unit 15a. For example, as coded information, the encoding unit 15b compresses logs using the word code allocation unit 14a to be described later. In addition, the encoding unit 15b creates an inverted index using the word code allocation unit 14a and the compressed logs. In addition, the encoding unit 15b stores the compressed log into the compressed log 14b of the storage unit 14. In addition, the encoding unit 15b stores the created inverted index into the inverted index 14c of the storage unit 14.

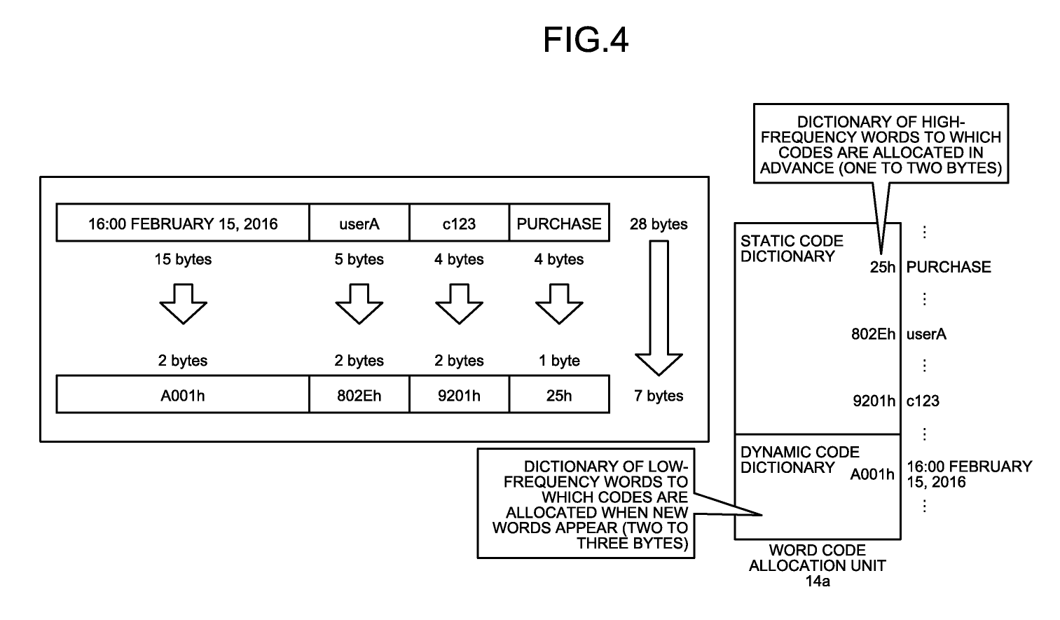

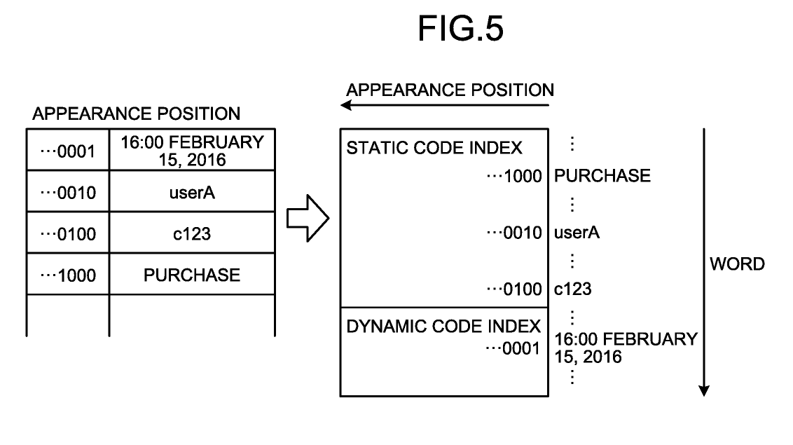

FIGS. 4 and 5 are explanatory diagrams for describing processing of the encoding unit 15b. First, as exemplified in FIG. 4, the encoding unit 15b encodes each word separated into items of logs, using the word code allocation unit 14a stored in the storage unit 14. Here, as exemplified in FIG. 4, the word code allocation unit 14a is information in which a word and a code with a small number of bytes that is to be allocated to each word are associated. The word code allocation unit 14a includes a pre-registered static code dictionary and a dynamic code dictionary to be sequentially registered. In other words, a code with one to two bytes is allocated in advance to a word with high frequency of appearance in a log, and the word is registered in the static code dictionary. On the other hand, a code with two to three bytes is allocated to a word with low frequency of appearance in a log, when the word appears, and the word is registered in the dynamic code dictionary. FIG. 4 illustrates that, for example, a code “25h” is pre-registered in the static code dictionary for a word “purchase”.

In addition, in the present embodiment, coded information includes an inverted index indicating an appearance position in a log of a word included in the log. In other words, as exemplified in FIG. 5, the encoding unit 15b creates a bit-mapped inverted index in which a word and an appearance position in a log of each word are associated, using the word code allocation unit 14a and the compressed log 14b. In the inverted index exemplified in FIG. 5, a vertical axis direction indicates the same word as each word corresponding to a position in the vertical axis direction of the word code allocation unit 14a, and a bit map indicating an appearance position in a log of each word corresponding to each position in the vertical axis direction is described. In other words, the inverted index includes a static code index corresponding to the static code dictionary of the word code allocation unit 14a, and a dynamic code index corresponding to the dynamic code dictionary. In addition, the appearance position may be represented as an appearance position in one log, or may be represented as an appearance position in a group of a plurality of logs.

In this manner, in the present embodiment, simultaneously with processing of performing compression of logs, the encoding unit 15b can create an inverted index through one-path processing. In addition, when a log is added, the encoding unit 15b needs not re-create an inverted index. Thus, an inverted index can be easily added.

Configuration of Server

As an embodiment, the server 20 can be implemented by the above-described analysis processing installing, onto a desired computer, an analysis program provided as packaged software or online software. For example, the server 20 can be implemented by installing the above-described analysis program onto an information processing apparatus used by an administrator of an internet shopping site. In addition to this, the server 20 can be implemented by installing the above-described analysis program onto a server device that accommodates an information processing apparatus used by the above-described administrator of the internet shopping site, or the like, as a client terminal. In this case, the server 20 may be implemented as part of a business system such as sales amount management, or may be implemented as a cloud that provides a service realized by the above-described analysis processing, by outsourcing.

The description will return to the description of FIG. 2. Functional units corresponding to signs 21 to 25 are illustrated in FIG. 2, but these functional units merely serve as an example, and do not prevent part of functional units illustrated in the drawing, from being omitted, or a functional unit other than those illustrated in the drawing, from being included in the server 20. For example, when an information processing apparatus used by the administrator of the internet shopping site is implemented as the server 20, in addition to functional units included in a personal computer, a portable terminal device, or the like, as a standard, such as an input device, an output device of an image or sound, and a communication interface, for example, a functional unit such as a reading unit such as a scanner may be included. In addition, when the server 20 is implemented as part of the above-described business system, a database that manages data that is other than a word code allocation unit 24a, a compressed log 24b, and an inverted index 24c, which will be described later, may be stored in a storage unit 24 of the server 20, such as a mains storage device and an auxiliary storage device, for example.

As illustrated in FIG. 2, as a mere example, the server 20 includes a communication unit 21, an input unit 22, an output unit 23, the storage unit 24, and a control unit 25. In addition, in FIG. 2, solid lines representing relationship of input and output of data are illustrated. Nevertheless, for the sake of convenience of description, only minimum parts are illustrated. In other words, input and output of data that are related to each processing unit are not limited to the example illustrated in the drawing, and input and output of data that are other than those illustrated in the drawing may be performed. For example, input and output of data between a processing unit and a processing unit, between a processing unit and data, or between a processing unit and an external device may be performed.

The communication unit 21 is a processing unit that controls, via the network 30, data communication between an external device such as the terminal 10, and the control unit 25. The communication unit 21 corresponds to a communication device such as an NIC, for example.

The input unit 22 is an input device for inputting various types of information to the server 20. For example, the input unit 22 corresponds to a mouse, a keyboard, a touch panel, an input button, or the like.

The output unit 23 is a display device that displays various types of information. For example, the output unit 23 corresponds to a display device such as an LCD and a CRT.

The storage unit 24 is a device that stores data used in an OS executed by the control unit 25, or various programs such as an application program. For example, the storage unit 24 is implemented as a main storage device in the server 20. For example, as the storage unit 24, various semiconductor memory elements such as, for example, a RAM and a flash memory can be employed. In addition, the storage unit 24 can also be implemented as an auxiliary storage device. In this case, an HDD, an optical disk, an SSD, or the like can be employed.

As an example of data used in programs executed by the control unit 25, the storage unit 24 stores the word code allocation unit 24a, the compressed log 24b, and the inverted index 24c as described later. In addition to the data, other types of electrical data can also be stored together in the storage unit 24.

The control unit 25 includes an internal memory that stores various programs and control data, and executes various types of processing using these.

For example, the control unit 25 is implemented as a central processor, that is to say, a so-called CPU. The control unit 25 needs not be always implemented as a central processor, and may be implemented as a MPU or a DSP. In this manner, the control unit 25 is implemented as a processor, and a type thereof is not especially limited to a general-purpose type or a specialized type. In addition, the control unit 25 can also be realized by a hard-wired logic such as an ASIC and an FPGA.

By executing various programs, the control unit 25 virtually realizes the following processing units. For example, as illustrated in FIG. 2, the control unit 25 includes an acquisition unit 25a and an analysis unit 25b.

The acquisition unit 25a is a processing unit that acquires coded information from the terminal 10. For example, the acquisition unit 25a acquires, as coded information, compressed logs, a word code allocation unit, and a created inverted index, from the terminal 10, and stores these into the storage unit 24. For example, the acquisition unit 25a accumulates the acquired word code allocation unit into the word code allocation unit 24a of the storage unit 24, accumulates the compressed logs into the compressed log 24b, and accumulates the inverted index into the inverted index 24c. In addition, the acquisition unit 25a updates the inverted index 24c accumulated in the storage unit 24, using the acquired inverted index. Here, the word code allocation unit 24a and the inverted index 24c that correspond to the compressed log 24b are associated with each other by a method such as a method of granting respective pieces of identification information.

The analysis unit 25b is a processing unit that analyzes information related to a terminal, using acquired coded information. For example, the analysis unit 25b analyzes tastes such as interests, customs, properties, behaviors, ways of using a terminal, and a living environment that are related to the user who operates the terminal. In this case, the analysis unit 25b calculates, using collaborative filtering, the number of times or frequency of product reference, the number of purchases, and the like, from logs of operations that indicate behaviors of the user, and calculates degrees of similarity between behaviors of the user and behaviors of other users. In addition, the analysis unit 25b creates information of products purchased by other users with high degrees of similarity in behaviors, as recommendation information, and presents the recommendation information to the terminal 10 of the analysis target user.

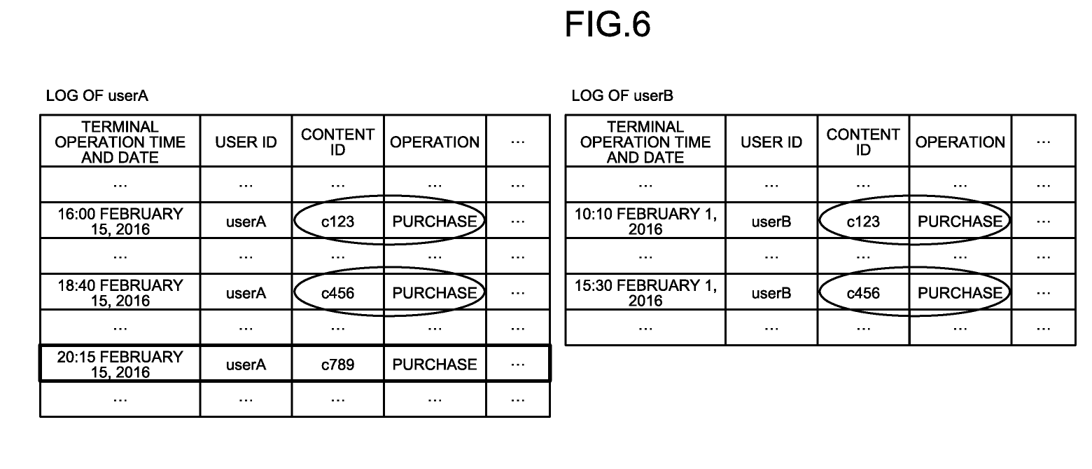

FIG. 6 is an explanatory diagram for describing processing of the analysis unit 25b. In the example illustrate d in FIG. 6, the analysis unit 25b determines, using collaborative filtering, that a degree of similarity in behaviors between a userA and a userB is high because both the userA and the userB purchase c123 and c456. Thus, the analysis unit 25b delivers information of c789 purchased by the userA, as recommendation information for the userB, to the terminal 10 used by the userB, and causes the output unit 13 to display.

Flow of Processing

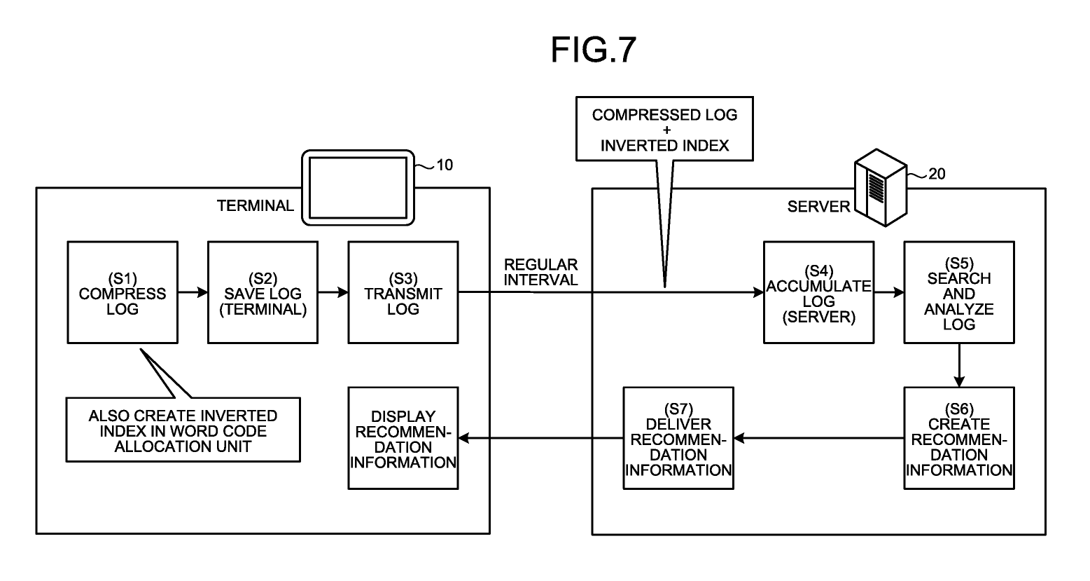

FIG. 7 is a diagram illustrating a flow of analysis processing according to the first embodiment. As an example, the analysis processing illustrated in FIG. 7 is started up when an operation instructing a processing start is input, for example. First, the collection unit 15a of the terminal 10 collects logs of operations performed by the user. Next, the encoding unit 15b compresses a log using the word code allocation unit 14a, as coded information obtained by encoding logs (Step S1), and saves the compressed log into the compressed log 14b of the storage unit 14 (Step S2). In addition, in the processing in Step S1, the encoding unit 15b simultaneously creates an inverted index using the word code allocation unit 14a, and saves the inverted index into the inverted index 14c. In addition, the encoding unit 15b transfers, at regular intervals, a word code allocation unit and an inverted index that correspond to the compressed log, to the server 20 (Step S3).

In the server 20, the acquisition unit 25a acquires the compressed log, the inverted index, and the word code allocation unit that have been transferred from the terminal 10, and accumulates these into the storage unit 24 (Step S4). In addition, the analysis unit 25b searches the compressed log accumulated in the compressed log 24b, using the corresponding inverted index and word code allocation unit, and analyzes tastes of the user who operates the terminal 10 (Step S5). In addition, the analysis unit 25b creates recommendation information for the user based on the analysis (Step S6), and delivers the recommendation information to the terminal 10 (Step S7). The terminal 10 that has received the recommendation information causes the output unit 13 to display the recommendation information. Through the above-described steps, a series of analysis processes end.

One Aspect of Effect

As described above, the analysis system 1 according to the present embodiment includes the terminal 10 and the server 20. The terminal 10 includes the collection unit 15a and the encoding unit 15b. The collection unit 15a collects logs of operations of the terminal 10, or logs of sensing information that is acquirable in the terminal 10. The encoding unit 15b creates coded information obtained by encoding logs. In the present embodiment, coded information includes an inverted index indicating an appearance position in a log of a word included in the log. The server 20 includes the acquisition unit 25a and the analysis unit 25b. The acquisition unit 25a acquires coded information from the terminal 10. The analysis unit 25b analyzes testes related to the user who operates the terminal 10, using the acquired coded information.

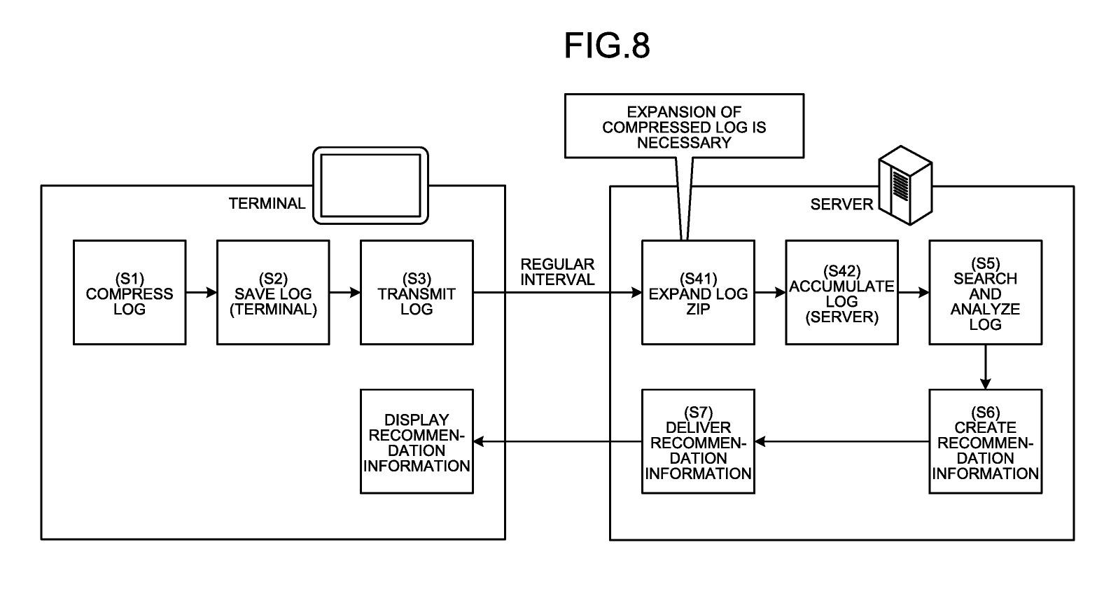

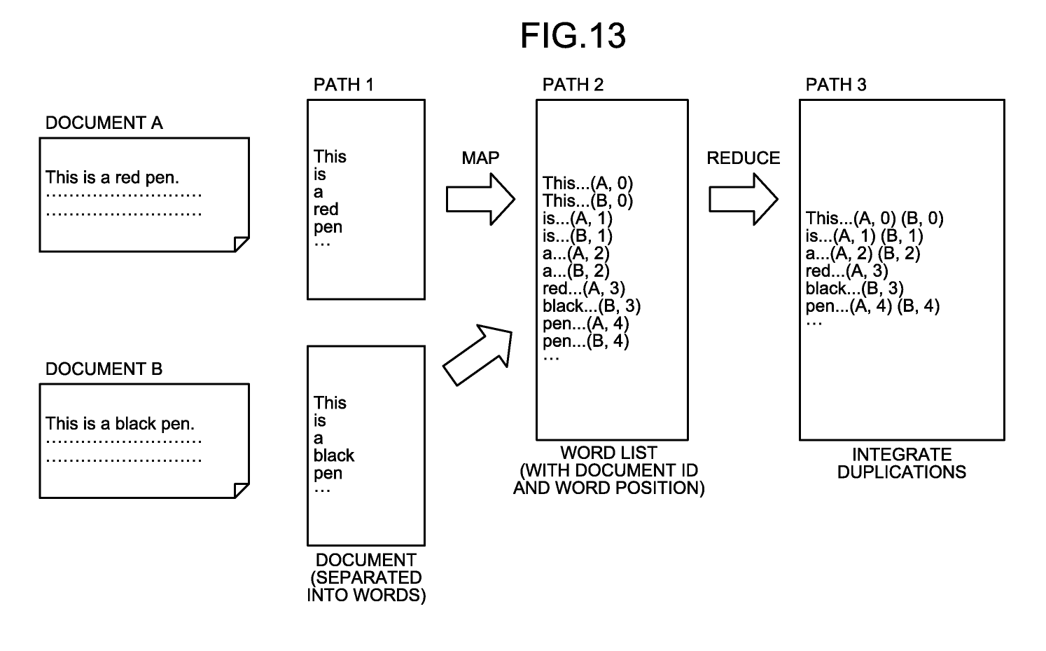

Here, FIG. 8 is a diagram illustrating a flow of conventional analysis processing. As exemplified in FIG. 8, in the conventional analysis processing, a terminal compresses a log in a format such as ZIP, for reducing load of processing of transferring collected logs to a server (Step S1). The server creates an inverted index using MapReduce or the like, for performing search when analyzing the acquired log (refer to FIG. 13). When creating an inverted index using MapReduce, the server needs to expand the compressed log (Step S41), and in addition, three-path processing is needed as described above.

In contrast to this, the analysis system 1 of the present embodiment can create an inverted index through one-path processing. In addition, the analysis system 1 can searches the compressed log acquired from the terminal 10, in an original format, without expanding the compressed log, and analyze tastes of the user. Thus, according to the analysis system 1 of the present embodiment, logs collected by the mobile terminal 10 can be analyzed in the server 20 with suppressed load.

### [b] Second Embodiment

The embodiment related to the disclosed device has been described so far. The present invention may be implemented in various different forms aside from the above-described embodiment. Thus, other embodiments included in the present invention will be described below. In addition, parts different from the above-described first embodiment will be described below.

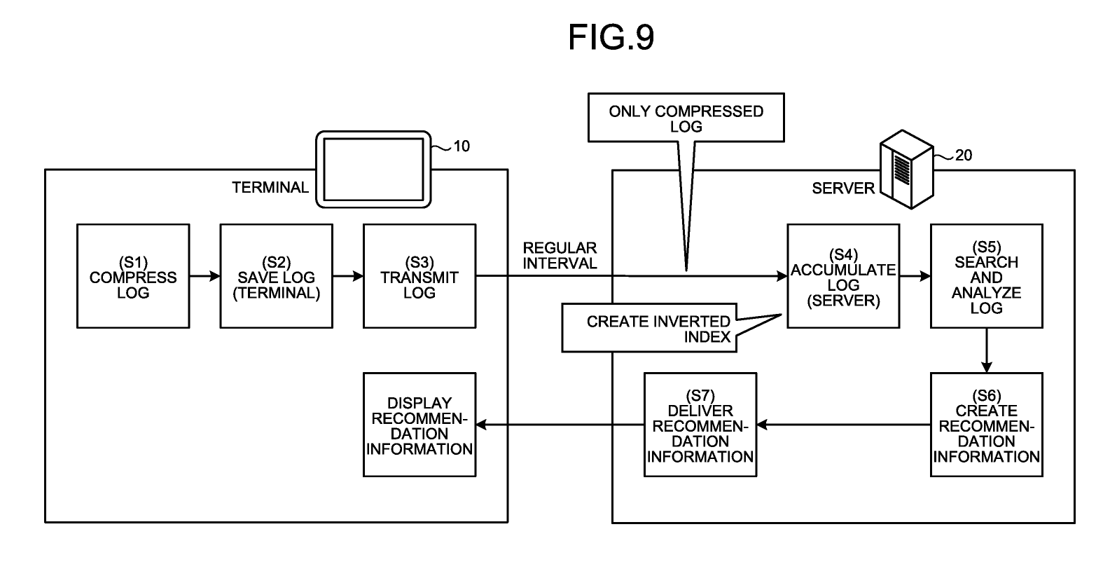

In the above-described first embodiment, when compressing a log, the encoding unit 15b of the terminal 10 simultaneously creates an inverted index, and transfers coded information including the compressed log and the inverted index, to the server 20. Nevertheless, the present invention is not limited to this. For example, the encoding unit 15b may create only a compressed log as coded information. FIG. 9 is a diagram illustrating a flow of analysis processing according to a second embodiment. In the present embodiment, coded information means a log compressed using the word code allocation unit 14a. In this case, as illustrated in FIG. 9, the encoding unit 15b of the terminal 10 transfers a word code allocation unit corresponding to the compressed log, to the server 20 (Step S3). Then, when the acquisition unit 25a of the server 20 acquires coded information not including an inverted index in this manner, the acquisition unit 25a creates an inverted index using the received word code allocation unit corresponding to the compressed log (Step S4).

In this manner, by the server 20 creating an inverted index, load of information transfer from the terminal 10 to the server 20 can be reduced. If an inverted index is not needed when the analysis unit 25b of the server 20 performs analysis of a log, the present embodiment is preferable.

### [c] Third Embodiment

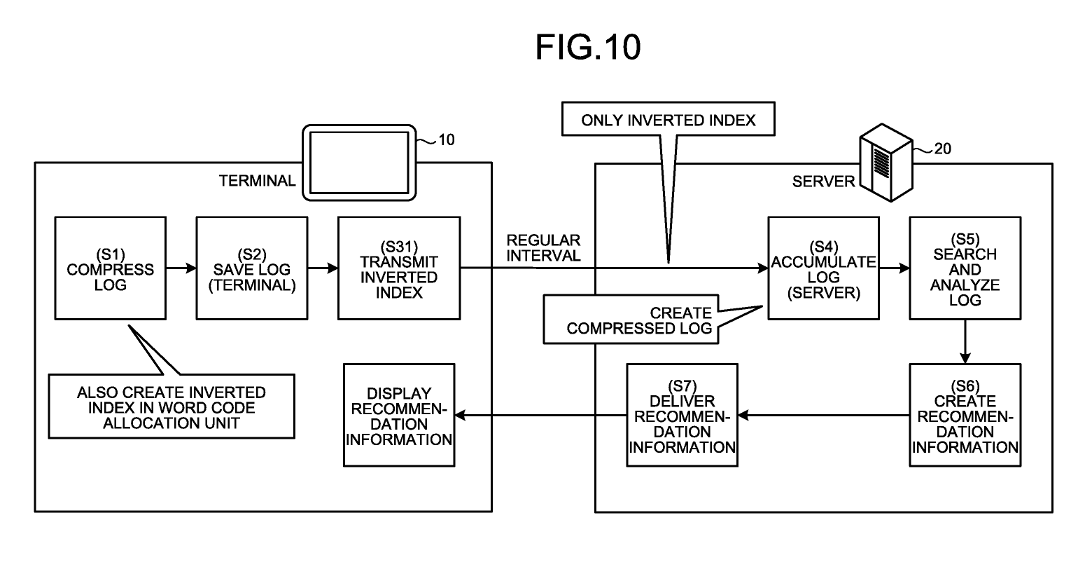

Aside from the above-described first and second embodiments, the encoding unit 15b of the terminal 10 may transfer an inverted index to the server 20 as coded information. FIG. 10 is a diagram illustrating a flow of analysis processing according to a third embodiment. In the present embodiment, coded information means an inverted index accompanied by the word code allocation unit 14a. In this case, when compressing a log (Step S1), the encoding unit 15b of the terminal 10 simultaneously creates an inverted index using the word code allocation unit 14a, and transfers a word code allocation unit corresponding to the inverted index, to the server 20 (Step S31). In addition, the acquisition unit 25a of the server 20 can create, that is to say, restore a compressed log using the received inverted index and the word code allocation unit.

In this manner, the terminal 10 transfers the word code allocation unit corresponding to the inverted index, to the server 20, as coded information, and does not transfer a compressed log, whereby load of information transfer from the terminal 10 to the server 20 can be drastically reduced. If the server 20 performs analysis using only an inverted index without using a log itself, the present embodiment is preferable.

### Application Example

The encoding unit 15b of the terminal 10 may switch whether to create an inverted index, according to a state of connection to a network that depends on a position of the terminal 10 or the like, a storage remaining amount, or a condition of resources such as batteries. For example, when a network environment is good, the encoding unit 15b transfers a compressed log and a word code allocation unit to the server 20 without creating an inverted index, whereby load on the terminal 10 can be reduced. In addition, when a network environment is bad, the encoding unit 15b creates an inverted index, and transfers the inverted index to the server 20, whereby a decline in update frequency of the inverted index can be prevented.

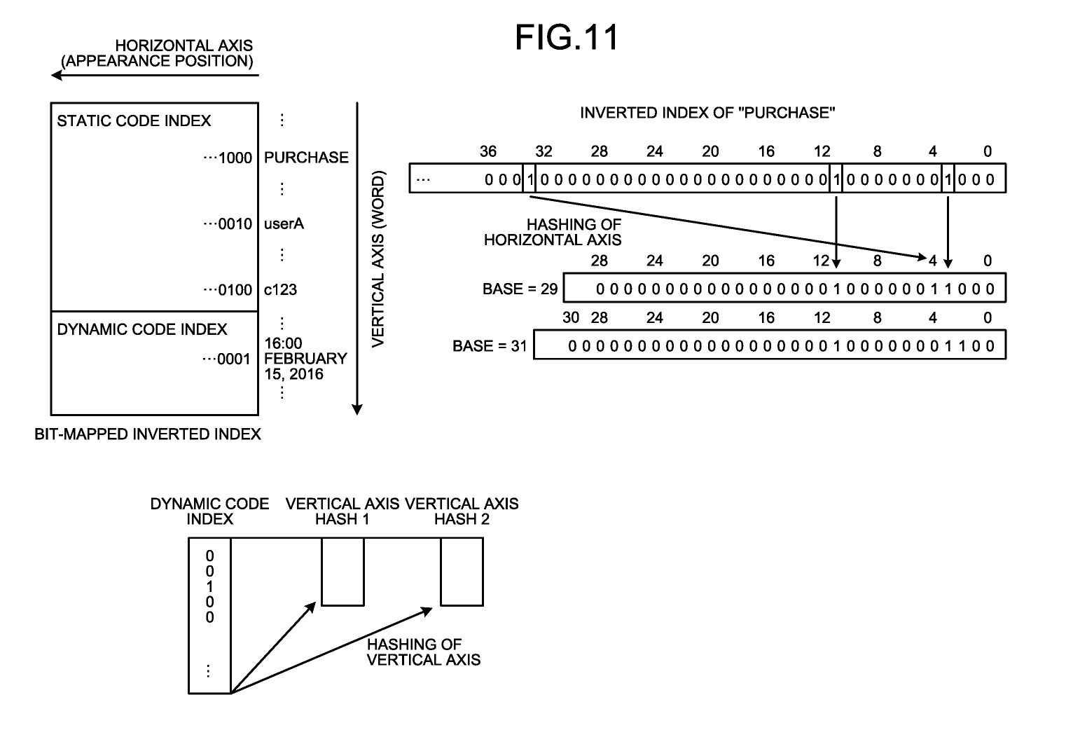

The bit-mapped inverted index created in the above-described first to third embodiments may be further compressed. FIG. 11 is an explanatory diagram for describing an inverted index according to an application example. As exemplified in FIG. 11, for example, by hashing a bit-mapped inverted index using two adjacent prime numbers as bases, a size can be reduced. FIG. 11 exemplifies that two inverted indices with reduced sizes that are obtained by performing hashing using 29 as a base, and using 31 as a base are generated. By performing such hashing for an appearance position of a word in a horizontal axis direction of a bit-mapped inverted index, or for a word in the vertical axis direction (information identifying a word), even if a dynamic code index increases, the dynamic code index can be easily added without making a memory scarce.

Analysis Program

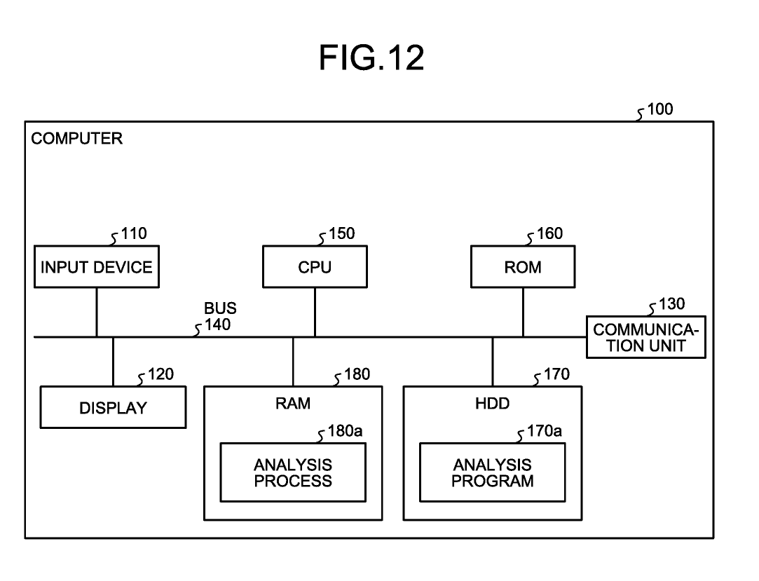

Various types of processing described in the above-described embodiments can be realized by executing programs prepared in advance, on a computer such as a personal computer and a work station. Thus, an example of a computer that executes an analysis program having functions similar to the above-described embodiments will be described below using FIG. 12.

FIG. 12 is a diagram illustrating a hardware configuration example of a computer that executes an analysis program. As illustrated in FIG. 12, a computer 100 includes an input device 110, a display 120, and a communication unit 130. Furthermore, the computer 100 includes a CPU 150, a read-only memory (ROM) 160, an HDD 170, and a RAM 180. These components 110 to 180 are connected via a bus 140.

As illustrated in FIG. 12, an analysis program 170a that exhibits functions similar to the control unit 15 illustrated in the above-described first embodiment is stored into the HDD 170. Similarly to the components of the control unit 15 that are illustrated in FIG. 2, the analysis program 170a may be integrated or separated. In other words, the HDD 170 needs not always store all pieces of data illustrated in the above-described first embodiment, and the HDD 170 is used to store data used in processing.

Under such an environment, the CPU 150 reads the analysis program 170a from the HDD 170, and loads the analysis program 170a onto the RAM 180. As a result, the analysis program 170a functions as an analysis process 180a as illustrated in FIG. 12. The analysis process 180a loads various types of data read from the HDD 170, into a region allocated to the analysis process 180a, among storage regions included in the RAM 180, and executes various types of processing using the loaded various types of data. In addition, in the CPU 150, all processing units illustrated in the above-described first embodiment need not always operate, and a processing unit corresponding to execution target processing is virtually realized.

In addition, the above-described analysis program 170a needs not be always stored in the HDD 170 or the ROM 160 from the beginning. For example, each program is stored into a “portable physical medium” such as a flexible disk, a so-called floppy disk (FD), a CD-ROM, a DVD disc, a magnetic optical disk, and an IC card that are inserted into the computer 100. Then, the computer 100 may acquire each program from these portable physical media, and execute each program. In addition, each program may be stored into another computer or a server device that is connected to the computer 100 via a public line, the internet, a LAN, a wide area network (WAN), or the like, and the computer 100 may acquire each program from these devices, and execute each program.

According to the embodiments, analysis of each terminal can be performed while suppressing analysis load in a server.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An analysis system comprising a terminal and a server,
wherein the terminal includes a first processor configured to:
collect a log of an operation of the terminal or a log of sensing information that is acquirable in the terminal; and
create coded information obtained by encoding the log, or index information indicating an appearance position in the log of a word included in the log that uses the coded information, and
wherein the server includes a second processor configured to:
acquire the coded information or the index information from the terminal, and when the coded information is acquired, create the index information; and
analyze information related to the terminal, using the index information.

2. The analysis system according to claim 1, wherein the second processor is further configured to:
when the index information is acquired, update the index information accumulated in the server, using the acquired index information.

3. The analysis system according to claim 1, wherein the first processor is further configured to:
switch whether to create the index information, according to a state of connection of the terminal to a network, or a condition of a resource.

4. An analysis method comprising:
collecting a log of an operation of the terminal or a log of sensing information that is acquirable in the terminal, using a terminal; and
creating coded information obtained by encoding the log, or index information indicating an appearance position in the log of a word included in the log that uses the coded information, using the terminal, and
acquiring the coded information or the index information from the terminal, and when the coded information is acquired, creating the index information, using a server; and
analyzing information related to the terminal, using the index information, using the server.

5. A non-transitory computer-readable recording medium having stored therein an analysis program that causes a computer to execute a process comprising:
collecting a log of an operation of a terminal which communicates with a server or a log of sensing information that is acquirable in the terminal; and
creating coded information obtained by encoding the log, or index information indicating an appearance position in the log of a word included in the log that uses the coded information, and
acquiring the coded information or the index information from the terminal, and when the coded information is acquired, creating the index information; and
analyzing information related to the terminal, using the index information.
